(19) United States
(12) Patent Application Publication
(10) Pub. No.: US 2004/0227347 A1
(43) Pub. Date: Nov. 18, 2004

(54) Adaptable water diverting fixture

(76) Inventors: Robert Lyle Fundin, Yucca Valley, CA (US); Richard Lee Fundin, Yucca Valley, CA (US); Jim A. Fundin, Palm Springs, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/437,209

(22) Filed: May 12, 2003

(51) Int. Cl. F16L 21/00

(52) U.S. Cl. 285/419

(57) ABSTRACT

An enclosure for diverting water spilled from an opened pipe joint includes a pair of housing halves which are able to be mounted on a pipe line and seal the pipe joint within the housing halves. The housing portions may be opened to allow the pipeline to be moved to position each pipe joint in turn within the housing. A plurality of seal sets provide the adaptability to seal the housing to different diameter pipes. The seal sets having a common outside diameter, and a unique inside diameter and are interchangeable within the housing. When the pipe joint is broken within the housing water in the pipe drains into the housing and from a nipple to a hose or other conduit to a drain or storage tank.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to plumbing fixtures and more particularly to such a fixture for diverting water from a vertical pipeline as the pipeline is being withdrawn from a well or other water source.

2. Description of Related Art

The following art defines the present state of this field:

Von Fange, U.S. Des. 453,671 describes a pipe clamp design.

Heeter, U.S. Pat. No. 1,427,811 describes an oil saver having a plurality of separable sections, packing members in each end of said sections adapted to engage casing portions of different diameters, the width of the contacting surfaces of the packing member at one end of the saver being materially greater than the width of the contacting surfaces of the packing member at the other end of the saver, said packing members of greater width being effective for preventing rotation of the portion of the casing engaged thereby during rotation of the portion of the casing engaged by the other packing members, and means for locking said sections about the casing to be drawn.

Shaffer, U.S. Pat. No. 2,163,327 describes an oil saver comprising hinged sections enclosing and spaced from the adjoining collar-end and plug-end of a drill string to form an annular closed chamber, the lower end of said chamber having a discharge-port below the collar, the upper end of each section having an interior integral longitudinally extending rib terminating at its lower end in a shoulder, and said shoulders seated on the upper free end of the collar.

Endsley, U.S. Pat. No. 2,505,282 describes a jacket for draining disconnected well pipe which includes, a pair of upright semi-cylindrical members vertically hinged to each other to open and close, a pair of hand levers pivotally mounted on one of said members, a latch pivotally mounted on the free edge portion of one of the members a keeper on the free edge portion of the other member engagable by the latch when the members are in closed position, and a movable element connecting one of the levers with the latch, the other lever having a pivotal connection with the member other than the member on which the levers are mounted.

Grable, U.S. Pat. No. 2,522,444 describes an oil well mud receptacle comprising a tubular body including a pair of sections adapted to be placed about a well pipe joint, a hinge interconnecting said sections, a cylinder connected to said body, and a piston in said cylinder and connected to said sections of tightly constricting them about the pipe.

Allemang, U.S. Pat. No. 2,634,812 describes a splash guard adapted to surround a length of pipe and comprising an upright elongated peripherally closed sleeve which is open at the top and bottom and which has two relatively rigid sleeve sections, hinge means hingedly connecting one of said sections at one of its lateral margins to a lateral margin of the other for swinging movement of the sections from a closed position in which the opposite lateral margins are together to close the sleeve to an open position in which the sleeve is open at one side for its full length for receiving an upright length of pipe radially, inwardly extending jaws connected to the sections, respectively, for movement therewith, and adapted, when the sections are moved into closed position, to embrace a length of pipe and frictionally clamp the sleeve thereto in fixed axial position thereon and for rotation therewith and with its peripheral wall in surrounding spaced relation to the pipe, spring means operatively connected at its opposite ends to the sections respectively and normally operable to move the sections and jaws into said closed position and to yieldably hold them in said closed position with the jaws so frictionally clamped to the pipe, said sections including means at a level above the jaws for closely surrounding the pipe when the sections are in closed position, handle means connected to the sections and adapted to be grasped in one hand of an operator and operated by said one hand for opening the sections, said spring means being of such strength that the sections can be moved to open position against the force of the spring means by said operation of the handle means by said one hand, and said sleeve being sufficiently light in weight so that it can be supported and held frictionally by the force of the spring means in said axial position on, and for said rotation with, the pipe and manipulated readily to and from operating position by said one hand.

Jones, Jr., U.S. Pat. No. 2,716,455 describes a device for trapping fluid in a pipe section being removed from a pipe string, comprising, in combination with a vertically disposed pipe string composed of pipe sections connected end-to-end by means of threaded joints, a generally tubular body removably mountable on said string surrounding a joint between upper and lower adjacent pipe sections, means for supporting said body on said upper section for movement upwardly therewith as it is unscrewed from the lower pipe section, and a horizontally disposed shutter member movably mounted on said body to close the bore thereof below said upper section as the latter is withdrawn from said lower section.

Matthies, U.S. Pat. No. 2,976,750 describes a coupling and uncoupling pipe tong comprising a first one-piece jaw assembly, a second sectional jaw assembly, each of said assemblies having an arcuate pipe coupling engaging jaw and a smaller diameter arcuate pipe engaging jaw, the jaws of the sectional assembly being unconnected with each other, means hinging the separate jaws of the sectional assembly to the one-piece assembly, and lever-operated eccentric means mounted on one assembly and operatively engagable with the other jaw assembly.

Bode, U.S. Pat. No. 5,295,536 describes a container for preventing spilling of drilling mud onto the rig floor to thereby save the mud for later reuse including a diametrically split and hinged barrel having a fixed lower seal assembly and a movable upper seal assembly which engage the outer wall of the drill pipe respectively below and above a joint connection that is to be unthreaded. Upon disconnection and upward movement, the upper seal moves upward with the pipe to totally eliminate wear which otherwise would result in seal and mud leakage.

The prior art teaches a pipe clamp, an oil saver for use in drawing old tubing from an oil well, a jacket for pipe joints of wet strings, a well fluid control device, a splash guard for oil well tubing, a trap for fluid in a pipe section, a multiple pivoted jaw pipe wrench, and a drilling mud container apparatus; but does not teach a jacket for containing drain-down of pipe strings that is adaptable for a range of different pipe sizes. The present invention fulfills these needs and provides further related advantages as described in the following summary.

### SUMMARY OF THE INVENTION

The present invention teaches certain benefits in construction and use which give rise to the objectives described below.

An enclosure for diverting water spilled from an opened pipe joint includes a pair of housing halves which are able to be mounted on a pipe line and seal the pipe joint within the housing halves. The housing portions may be opened to allow the pipeline to be moved to position each pipe joint in turn within the housing. A plurality of seal sets provide the adaptability to seal the housing to different diameter pipes. The seal sets having a common outside diameter, and a unique inside diameter and are interchangeable within the housing. When the pipe joint is broken within the housing water in the pipe drains into the housing and from a nipple to a hose or other conduit to a drain or storage tank.

A primary objective of the present invention is to provide an apparatus and method of use of such apparatus that provides advantages not taught by the prior art.

Another objective is to provide such an invention capable of being mounted on a variety of different sized pipes.

A further objective is to provide such an invention capable of draining water from a pipe line to a drain or storage tank without leaking water or draining into well or sump, etc.

A still further objective is to provide such an invention capable of being quickly adapted for use from one pipe size to the next.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is an exploded perspective view of the preferred embodiment of the invention shown in relationship to a pipeline workpiece;

FIG. 2 is a full vertical cross-section view thereof illustrating the manner in which the invention is placed about a pipe joint of the pipeline;

FIG. 3 is a full vertical cross-section view thereof illustrating the manner in which a pipe portion of the pipeline is pulled away from the pipeline enabling water therein to drain into the invention; and

FIGS. 4 and 5 are partial vertical cross-section views thereof illustrating the manner in which the invention is adaptable for sealing on different pipe diameters.

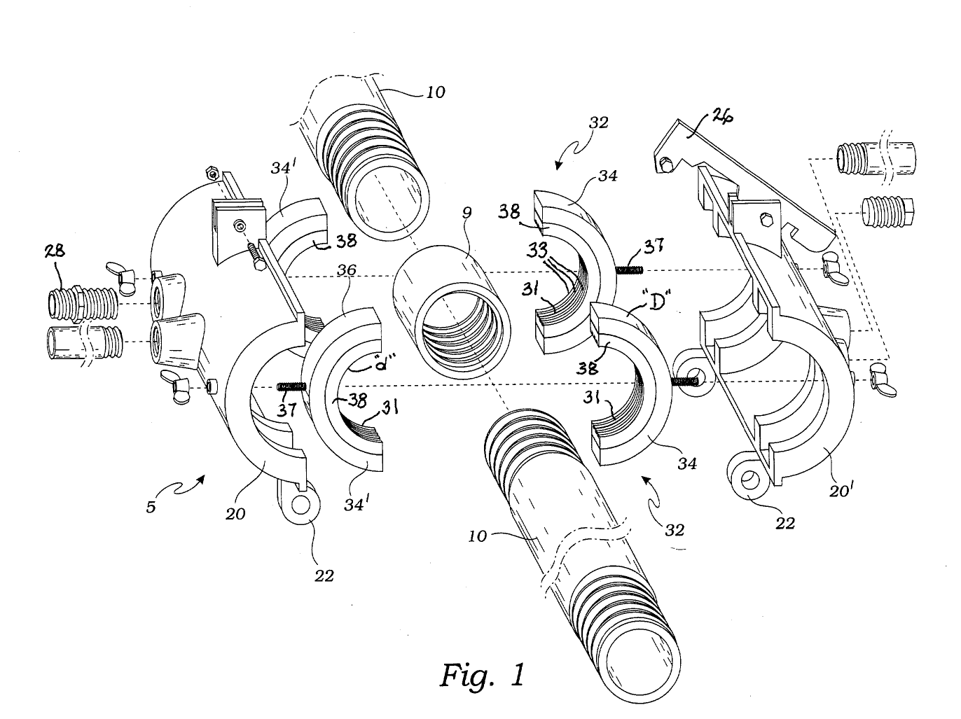

### DETAILED DESCRIPTION OF THE INVENTION

The above described drawing figures illustrate the invention in at least one of its preferred embodiments, which is further defined in detail in the following description.

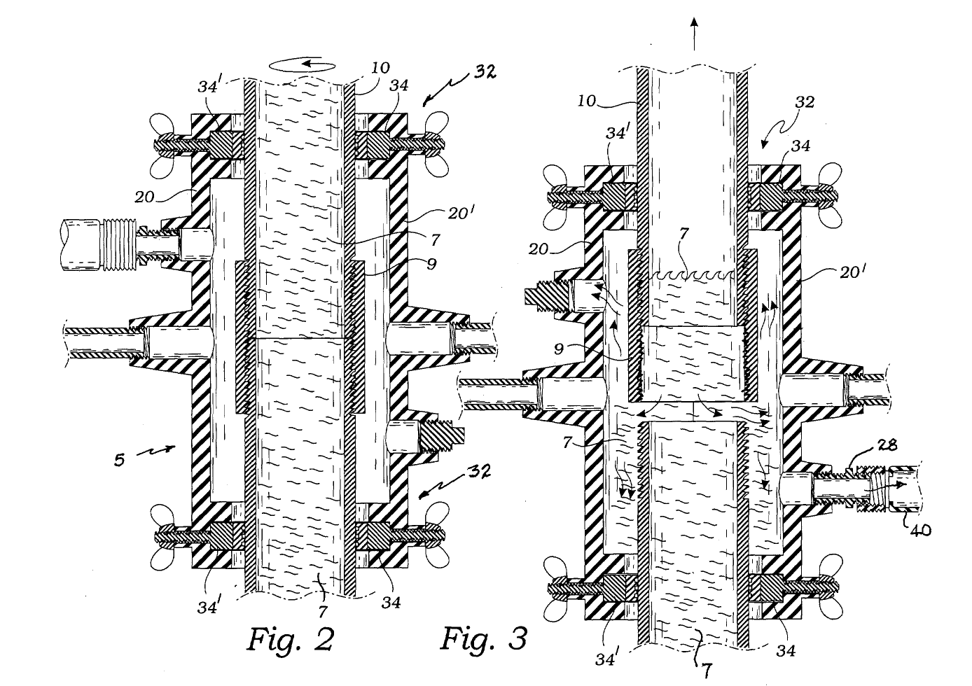

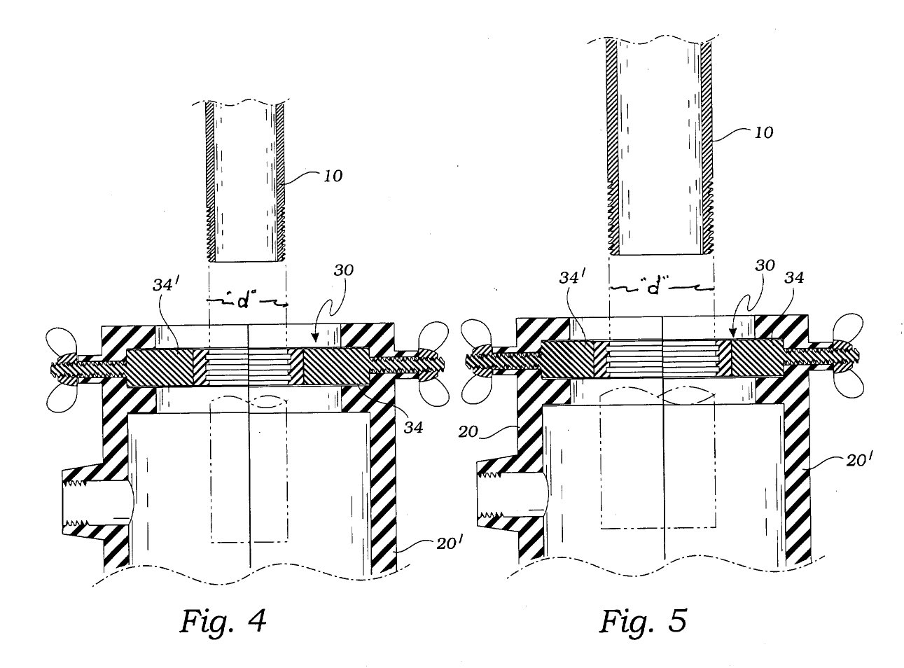

The present invention is an enclosure apparatus 5 for diverting water 7 spilled from an opened pipe joint 9 of a pipeline 10. The apparatus 5 comprises the combination of a pair of housings including a first housing portion 20 and a second housing portion 20′. These housing portions 20, 20′ are rotationally joined by a hinge 22 enabling the housing portions 20, 20′ to move between a closed orientation illustrated in FIGS. 2-5, for tightly engaging the pipeline 10, and an open orientation for repositioning the apparatus 5 on the pipeline 10. A plurality of seal sets are all individually reference by numeral 30. As can be seen from FIGS. 4 and 5, the seal sets 30 are of various sizes and may comprise many seal sets 30 each of a different size. This is illustrated by the two different sizes shown in FIGS. 4 and 5. All of the seal sets 30 have a common outside diameter “D” and each one of the seal sets 30 has a unique inside diameter “d” whereby each one of the seal sets 30 is specifically adapted for tight engagement about a specific pipe diameter. Therefore, in this application, “different sizes,” refers to the inside diameter “d” only, while the outside diameter of the seal sets 30 are all equal.

Each of the seal sets 30 comprise two seals 32 and each of the seals 32 comprises a first 34 and a second 34′ seal halves. Each of the seal halves 34, 34′ comprises a semicircular 7. structural rigid seal backing plate 36 supporting, in a nested relationship, a semicircular compliant sealing ring portion 38. The first and second housing portions 20, 20′, together, provide a pair of spaced apart circular acceptance grooves 24, the grooves sealingly engaging a selected one of the plurality of seal sets 30, i.e., any one of the seal sets 30, for tight-fitting about the pipeline 10, i.e., the grooves 24 conform to the shape of the seal sets 30 for leak resistant interlocking. The housing portions 20, 20′ provide a means for locking 26 the apparatus 5 about the pipeline 10 with the pipe joint 9 positioned between the seals 32, whereby when the pipe joint 9 is opened, water in an upper one of the pipes 11 drains into the apparatus 5. This process is shown in FIG. 3. The locking means 26 is preferably a handle which locks the two housing portions 20, 20′ together.

A hose nipple 28, for instance, is positioned in at least one of the housing portions 20, 20′ whereby a hose 40 may be engaged with the hose nipple thereby enabling water 7 within the apparatus 5 to be directed therefrom, as for instance to a drain or to a storage vessel (not shown).

The seals 32 preferably provide a circular contact surface 31, having a diameter approximately equal to the diameter of the pipeline 10 about which it seals. Preferably, this contact surface 31 provides a plurality of circular contact lips 33 protruding inwardly therefrom. Such protruding lips 33 provide an improved sealing capability as they form a plurality of circular sealing surfaces. Each one of the backing plates 36 provides a means for fastening the plates 36 tightly within one of the acceptance grooves 24 and such fastening means is preferably a threaded stud 37.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. An enclosure apparatus for diverting water spilled from an opened pipe joint of a pipeline, the apparatus comprising in combination: a first housing portion and a second housing portion, the housing portions rotationally joined by a hinge enabling the housing portions to move between a closed orientation for tightly engaging the pipeline and an open orientation for repositioning the apparatus on the pipeline; a plurality of seal sets, the seal sets having a common outside diameter, each of the seal sets having a unique inside diameter, each of the seal sets comprising two seals; each of the seals comprising a first and a second seal halves, each of the seal halves comprising a semicircular structural rigid seal backing plate supporting, in a nested relationship, a semicircular compliant sealing ring portion; the first and second housing portions, together, providing a pair of spaced apart circular acceptance grooves, the grooves engaging a selected one of the plurality of seal sets for tight-fitting about the pipeline; the housing portions providing a means for locking the apparatus about the pipeline with the pipe joint positioned between the seals; whereby when the pipe joint is opened, water in an upper one of the pipes drains into the apparatus.

2. The apparatus of claim 1 further comprising a hose nipple in at least one of the housing portions; a hose engaged with the hose nipple enabling water within the apparatus to be directed therefrom.

3. The apparatus of claim 1 wherein the seals provide a circular contact surface, the contact surface having a diameter approximately equal to a diameter of the pipeline.

4. The apparatus of claim 3 wherein the contact surface provides a plurality of circular contact lips protruding inwardly therefrom.

5. The apparatus of claim 1 wherein each one of the backing plates provides a means for fastening the one of the backing plates within one of the acceptance grooves.

6. The apparatus of claim 5 wherein the fastening means is a threaded stud.
